(19) United States
(12) Patent Application Publication
(10) Pub. No.: US 2009/0232313 A1
(43) Pub. Date: Sep. 17, 2009

(54) Method and Device for Controlling Security Channel in Epon

(76) Inventors: Jee Sook Eun, Cheonlabook-do (KR); Kyeong Soo Han, Daejeon (KR); Yool Kwon, Busan (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/083,178

(22) PCT Filed: Dec. 5, 2006
(86) PCT No.: PCT/KR2006/005199

§ 371 Date: Apr. 3, 2008

(30) Foreign Application Priority Data
Dec. 8, 2005 (KR) 10-2005-0119201
Jun. 7, 2006 (KR) 10-2006-0051129

(51) Int. Cl. H04L 9/08; H04L 9/00

(52) U.S. Cl. 380/278; 380/256

(57) ABSTRACT

A method and device for controlling security of a communication channel between an OLT and an ONU in a secure channel control system of EPON formed of the OLT and the ONU having a cryptographic module, a key management module and a transmitter/receiver for transmitting/receiving frames, the method comprising the steps of: a) distributing a key between the OLT and the ONU; b) transferring the distributed key to the encryption modules of the OLT and ONU; c) activating a corresponding encryption module using the distributed key at one of the OLT and the ONU which starts a security function activation; d) transmitting an encryption module information message including activation state information of the corresponding encryption module from the side (transmitting side) having the activated encryption module to an opponent side (receiving side); and e) activating an encryption module by checking activation state information of the encryption module at the receiving side.

### TECHNICAL FIELD

The present invention relates to a method and device for controlling a security channel; and more particularly, to a method and device for controlling a security channel through an upstream/downstream data channel security function in an Ethernet passive optical access network.

### BACKGROUND ART

As the communication technologies have been developed, exchanging information through networks has become popularized. Accordingly, diversity information has been exchanged and the amount of information to be exchanged has greatly increased. However, the information transferred through a communication channel may be opened or illegally used by unauthorized persons. Therefore, a security has become a very important issue in exchanging information through the communication channel. However, general users do not sufficiently perform security processes due to lack of knowledge about the security problem. Recently, the concern about technologies for securing a communication channel has abruptly increased.

As the number of Internet users using wireless communication technologies abruptly increased, high-speed Internet technologies have been rapidly developed in order to provide faster Internet services to users. A wireless LAN technology is one of representative technologies for the high-speed Internet service. However, the wireless LAN has shortcomings such as a large gab between a wide-area network and an end-user, and a bottleneck problem at an end-user. In order to overcome the bottleneck problem, a passive optical network (PON) was introduced. The PON is a system that transfers a signal to an end-user through an optical cable network. The PON is classified into FTTC, FTTB or FTTH by a location of an end-processing. The PON is formed of an optical line terminal (OLT) that is installed at a communication company and a plurality of optical network units (ONU) that are installed around the OLT. Such a PON technology may be classified into ATM PON (APON) and Ethernet PON (EPON).

The EPON technology is a network access control technology that can provide various communication services such as Internet, Internet TV, digital TV and telephone through one optical fiber line to home.

Since the security of a communication channel is also important in the EPON, a technology for securing a communication channel is required.

Since the security of communication channel between an object A and an object B in the network is established as the security of communication channel between a service provider and a service consumer, the service provider, which is a transmitting side, authenticates, distributes a key, and manages the key in order to activate the security function.

In an operation for activating a security function in a wireless LAN, a key is distributed at an access point after authenticating a terminal as shown in FIG. 1, and a security function is activated without additional authentication. Then, encoded frames are transmitted. Since the 4-way Handshake of IEEE 802.11i is performed to update a key, the key modification always begins at an access point.

A case of beginning changing a key at an access point is suitable to a case of using a same key in transmitting/receiving channels. Therefore, it is difficult to find an exact point of changing a key in a receiving channel when two keys are used in the transmitting/receiving channels.

Furthermore, in case of a wireless LAN, a security function is deactivated only by the request of a terminal, and a function for defending a denial of service (DoS) attack is not provided.

### DISCLOSURE OF INVENTION

### Technical Problem

One object of the present invention is to provide a method and device for controlling a security channel for activating a security function after distributing a key and deactivating a security function while performing the securing function.

Another object of the present invention is to provide a method and device for controlling a security channel for activating and deactivating a security function when a function for detecting denial of service (DoS) is applied in an Ethernet passive optical network.

A further object of the present invention is to provide a device and method for controlling a security channel for changing a type of encoded frame which is an object of a denial of service (DoS).

### Technical Solution

In order to achieve the above objects, the present invention provides a method of controlling security of a communication channel between an optical line terminal (OLT) and an optical network unit (ONU) in a secure channel control system of an Ethernet passive optical network formed of an optical line terminal and an optical network unit having a cryptographic module, a key management module and a transmitter/receiver for transmitting/receiving frames, the method including the steps of: a) distributing a key between the OLT and the ONU; b) transferring the distributed key to the encryption modules of the OLT and ONU; c) activating a corresponding encryption module using the distributed key at one of the OLT and the ONU which starts a security function activation; d) transmitting an encryption module information message including activation state information of the corresponding encryption module from the side (transmitting side) having the activated encryption module to an opponent side (receiving side); and e) activating an encryption module by checking activation state information of the encryption module at the receiving side.

According to an aspect of the present invention, there is provided a method of controlling security of a communication channel between an optical line terminal (OLT) and an optical network unit (ONU), in a secure channel control system of an Ethernet passive optical network having an optical line terminal (OLT) and an optical network unit (ONU) including an encryption module, a key management module and a transmitter/receiver for transmitting and receiving a frame, the method including the steps of: a) distributing a key between the OLT and the ONU; b) transmitting the distributed key to an encryption module of the OLT and the ONU; c) activating a corresponding encryption module at one between the OLT and the ONU which starts activating a security function using the distributed key; d) transmitting an encryption module information message including activation state information of the corresponding encryption module from the side having the activated encryption module (transmitting side) to an opponent side (receiving side); e) activating an encryption module by checking activation state information of the encryption module at the receiving side that receives the encryption module information message; and f) activating a function of sensing denial of service of each encryption module as the encryption modules of the transmitting side and the receiving side are activated.

According to another aspect of the present invention, there is provided a method of controlling security of a communication channel between an optical line terminal (OLT) and an optical network unit (ONU) in a security channel control system in an Ethernet passive optical network having an encryption module, a key management module and a transmitter/receiver for transmitting and receiving a frame, the method including the steps of: deactivating a function of sensing denial of service in a side (receiving side) receiving the frame among the OLT and the ONU when one of the OLT and the ONU requests encryption data information to change; transmitting an encryption module information message from the receiving side to an opponent side (transmitting side); comparing the encryption module information message with encryption data information and pre-stored data information to determine whether they are matched or not at the transmitting side; transmitting encryption module information message for changing encryption data information to the receiving side when the encryption data information is not matched; comparing encryption data information including an encryption module information message received from the transmitting side to own encryption data information at the receiving side to determine whether they are matched; and activating a function of sensing denial of service at the receiving side when the encryption data information are matched.

According to further another aspect of the present invention, there is provided an apparatus for controlling security of channel between an optical line terminal (OLT) and an optical network unit (ONU) in an Ethernet passive optical network having the OLT and the ONU as a transmitter and a receiver for transmitting or receiving a frame, the apparatus including: an encryption module for activating and deactivating according to a request from one starting activating and deactivating a security function between the OLT and the ONU, and activating an encryption module of the opponent side by transmitting an encryption module information message including information noticing that the encryption module is activated or deactivated to the opponent side; and a key management module for distributing a key between the optical line terminal (OLT) and the optical network unit (ONU) before activating the encryption module, and transmitting the distributed key to the encryption module of the OLT and the ONU.

### Advantageous Effects

The present invention can maintain a transmission/reception securing channel, which is independent to each other, by activating and deactivating the securing function in the cryptographic module of the transmitting unit (Tx). Since the securing function is activated in connected with the key allocation of the transmitting unit (TX) capable of acquiring an exact key changing time, the present invention can exactly acquire the securing function activating time of the transmitting unit (TX) by transmitting one message.

Also, by applying the function for sensing the DoS attack, the present invention can prevent that the frame transmitted in a state change of the securing function is considered as the DoS attack and lost, and the organization information of the data encoding information can be changed without disconnecting the securing channel.

### BRIEF DESCRIPTION OF THE DRAWINGS

The above objects, other features and advantages of the present invention will become more apparent by describing the preferred embodiments thereof with reference to the accompanying drawings, in which:

FIG. 1 is a flowchart illustrating a security access in a wireless LAN according to the related art;

FIG. 2 is a schematic structural diagram illustrating the structure of EPON according to an exemplary embodiment of the present invention;

FIG. 3 is a structural diagram illustrating the structure of an apparatus for controlling a security channel in EPON according to an exemplary embodiment of the present invention;

FIGS. 4 and 5 are flow diagram illustrating the process for distributing a key;

FIG. 6 is a flow diagram illustrating the operation of activating a cryptographic module in EPON;

FIG. 7 and FIG. 8 are flow diagrams illustrating the operation of inactivating an encryption function in EPON according to an embodiment of the present invention;

FIG. 9 is a flowchart describing an operation for activating a cryptographic module including a DoS attack sensing function in the EPON according to a second embodiment of the present invention;

FIGS. 10 and 11 are flowcharts describing an operation for deactivating an encryption module including a function of sensing DoS in EPON according to an embodiment of the present invention;

FIGS. 12 and 13 are flowcharts describing an operation for changing encoding data according to the second embodiment of the present invention; and

FIG. 14 shows a structure of an information key managing frame according to an embodiment of the present invention.

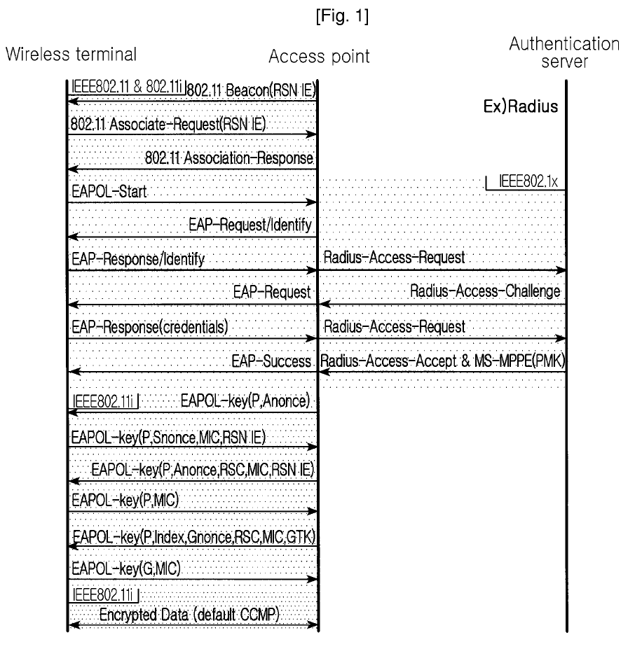

### BEST MODE FOR CARRYING OUT THE INVENTION

Hereinafter, preferred embodiments of the present invention will be described in detail with reference to the attached drawings.

Although the preferred embodiments of the present invention have been disclosed for illustrative purpose, those skilled in the art will appreciate that various modifications, additions and substitutions can be made without departing from the scope and spirit of the invention as defined in the accompanying claims.

A schematic structure of EPON according to an exemplary embodiment of the present invention will now be described.

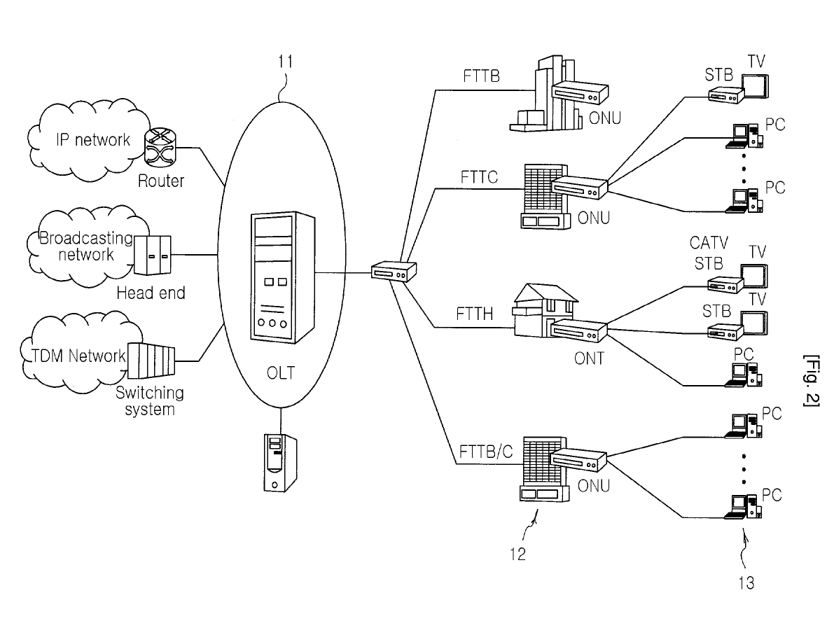

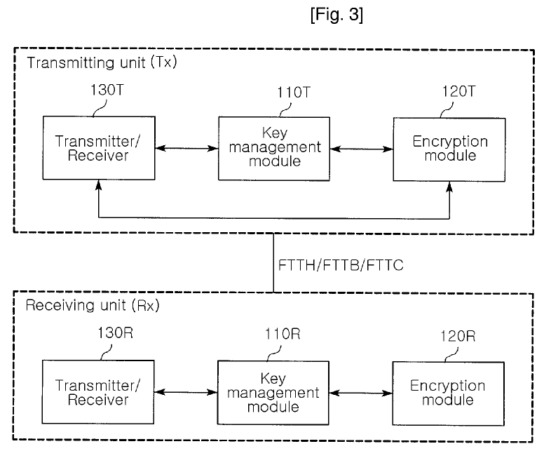

FIG. 2 is a schematic structural diagram illustrating the structure of EPON according to an exemplary embodiment of the present invention. FIG. 3 is a structural diagram illustrating the structure of an apparatus for controlling a security channel in EPON according to an exemplary embodiment of the present invention.

Referring to FIG. 2, the EPON system includes an optical line terminal (hereinafter, referred to as “OLT”) 11 for connecting with another systems such as IP network, broadcasting network, and TDM network, and optical network units (hereinafter, referred to as “ONUs”) 12 that are located at the subscriber-side end of the EPON and connected to subscriber terminals 13 such as STB, PC, and the like. The OLT 11 and the ONUs 12 each have a key that is distributed for the security of communication channels. The OLT 11 and the ONUs 12 can be both transmitting side and receiving side. Note that as a side that encrypts frames begins the activation and inactivation of a security function, the side that encrypts frames becomes a transmitting side TX, and the other side that receives the encrypted frames becomes a receiving side RX.

As shown in FIG. 3, the apparatus for controlling the security channel in the EPON may be divided into a transmitting side TX and a receiving side RX. The transmitting side TX and the receiving side RX include key management modules 110T and 110R for distributing and verifying keys therebetween, cryptographic modules 120T and 120R for encrypting and decrypting frames after the key distribution, and transmitters/receivers 130T and 130R for transmitting and receiving the frames and cryptographic module information messages including the status information of the cryptographic modules, respectively.

The key management modules 110T and 110R transfer the distributed keys to the cryptographic modules 120T and 120R to encrypt and decrypt frames to be transmitted and received after completing a key distribution process.

A method of controlling a security channel in EPON having the aforementioned structure will be described in detail with reference to the attached drawings. At first, a key distribution process between an OLT 11 and an ONU 12 will be described.

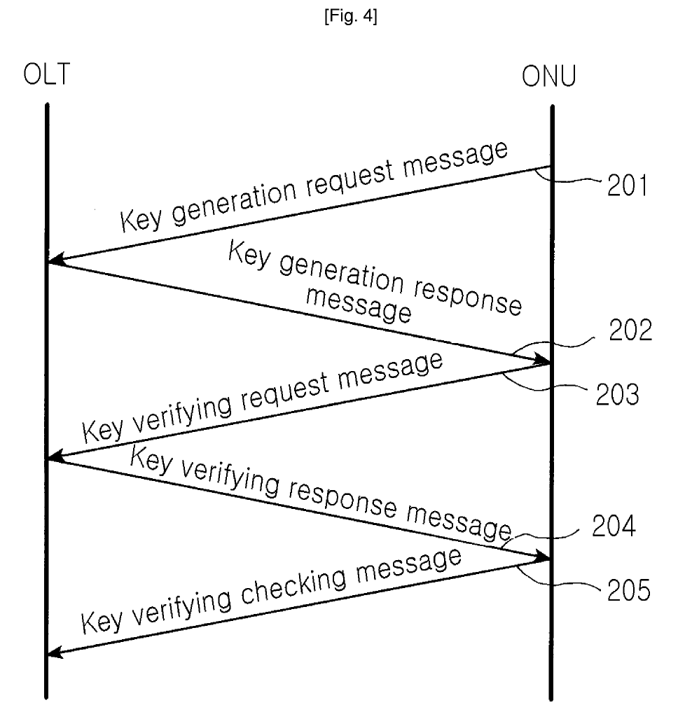

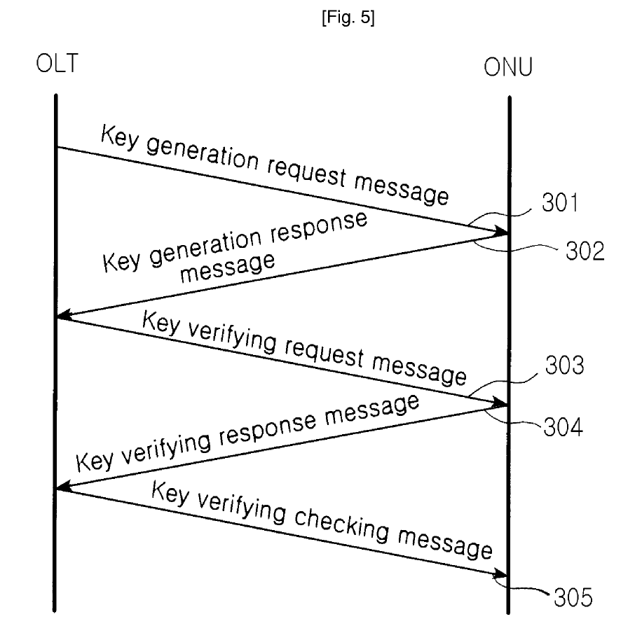

FIGS. 4 and 5 are flow diagram illustrating the process for distributing a key.

The key distribution between the OLT 11 and ONU 12 in the EPON may begin by the OLT 11 as shown in FIG. 4, or by the ONU 12 as shown in FIG. 5.

Referring to FIG. 4, the OLT 11 starts the operation for distributing a key and waits to receive a key generation request message from the ONU 12. When receiving the key generation request message from the ONU 12 at step S201, the OLT 11 transmits a key generation response message to the ONU 12 to respond that it is possible to generate a key at step S202.

When receiving a key verification request message at step S203, the OLT 11 performs key verification and transmits a key verification response message at step S204. Then, the OLT 11 receives a key verification acknowledgement message and terminates the key distribution process at step S205.

In the case that the ONU 12 starts the key distribution, as shown in FIG. 5, the ONU 12 operates the same as the OLT 11 shown in FIG. 4 in response to the reception of a key generation request message.

When receiving the key verification acknowledgement message that means the termination of the key distribution process after performing the key distribution process, the OLT 11 and the ONU 12 have the key that has completed to verify and can decrypt the received encrypted frames.

After the key distribution process, a transmitting side and a receiving side perform encryption and decryption. The operation of activating a cryptographic module will now be described in detail with reference to the attached drawings. Here, the OLT 11 and the ONU 12 can be both a transmitting side and receiving side. Note that a side that transmits a key verification acknowledgement message becomes a transmitting side TX, and that a side that receives the message becomes a receiving side. Hereinafter, the OLT 11 and the ONU 12 will be considered a transmitting side and a receiving side, respectively.

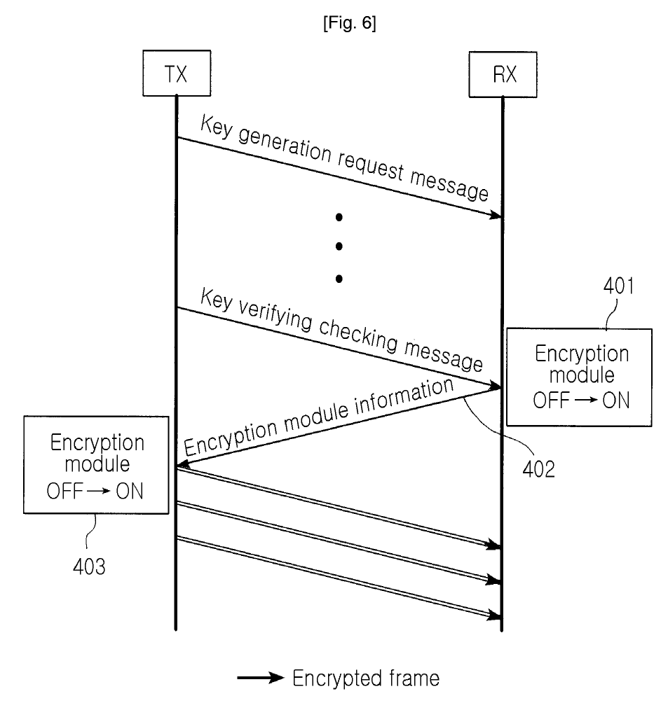

FIG. 6 is a flow diagram illustrating the operation of activating a cryptographic module in EPON.

Referring to FIG. 6, when the transmitting side TX transmits a key verification acknowledgement message through a key distribution process, the receiving side RX activates the cryptographic module 120 at step S401 and transmits a cryptographic module information message to the transmitting side TX at step S402.

The transmitting side TX then checks a possible time to encrypt frames, ascertains that the cryptographic module 120R in the receiving side RX is activated (“ON”), and activates the cryptographic module 120T at step S403. Then, the transmitting side TX encrypts frames and transmits the encrypted frames to the receiving module RX. This method can prevent security frames to being lost while the receiving side RX is not activated (“OFF”) since it checks the state of the security function of the receiving side RX to activate the transmitting side TX.

Meanwhile, it may be possible to apply or not to apply a security function to communication channels with a predetermined ONU in the EPON in response to a request of a service provider. Accordingly, the cryptographic module should be changed from an activate state to an inactivate state. In order to perform this operation, the receiving side RX should perceive the deassertion of the cryptographic module that the transmitting side TX has performed at discretion, and should deassert the cryptographic module.

However, some frames may be not encrypted according to a request of a service provider. Therefore, although the receiving side RX receives non-encrypted frame, changing the state of the cryptographic module into “OFF” cannot be an accurate decision criterion to determine the termination of the security function. Accordingly, the receiving side RX requires information to determine whether the transmitting side TX inactivates an encryption function. The procedure of inactivating the encryption function will now be described with reference to the attached drawings.

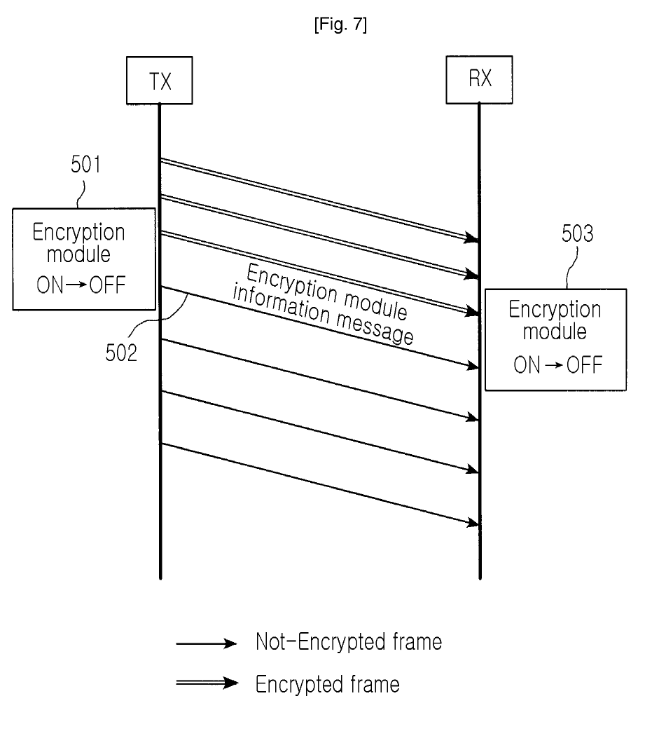

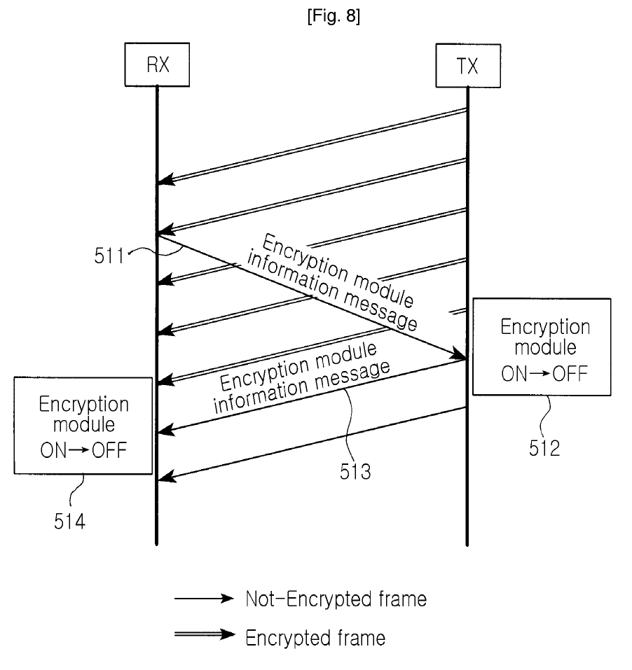

FIG. 7 and FIG. 8 are flow diagrams illustrating the operation of inactivating an encryption function in EPON according to an embodiment of the present invention.

Referring to FIG. 7, when a transmitting side TX starts the procedure of inactivating a security function, it is not necessary for a transmitting side to inactivate a cryptographic module 120T depending on a setup result of a receiving side RX. Therefore, the transmitting side TX does not wait for the setup result of the receiving side RX and immediately inactivates the cryptographic module 120T at step S501. Next, the transmitting side TX transmits a cryptographic module information message including information that indicates the current state of the cryptographic module 120T to the receiving side RX at step S502. Then, the receiving side RX ascertains the received cryptographic module information message and inactivates the cryptographic module 120R at step S503.

On the other hand, referring to FIG. 8, in the case that a receiving side RX starts the procedure of inactivating a security function, the receiving side RX transmits a cryptographic module information message that causes the transmitting side TX to inactivate the cryptographic module 120T to the transmitting side at step S511. Then, the transmitting side TX inactivates the cryptographic module 120T at step S512, and transmits a cryptographic module information message including information that indicates the current state of the cryptographic module 120T to the receiving side RX at step S513. According to this operation, the receiving side RX ascertains the received cryptographic module information message and inactivates the cryptographic module 120R at step S514.

According to the first embodiment of the present invention as described above, in the case that a transmitting side TX starts to control a cryptographic module, a transmitting side TX is a side that encrypts frames and a receiving side RX is a side that decrypts frames. Unlike this, in the case that a receiving side RX starts control, that is, the distribution of a key for decrypting frames, the receiving side RX receives a key verification acknowledgement message and becomes a state of having the key that has been completed to verify so that it can activate the cryptographic module 120T. This method can reduce decision time to determine the state of the security function by abbreviating one of control frames for the procedure of the decision.

In EPON using GCM-AES (Galois/Counter Mode of Operation-Advanced Encryption Standard) that is an encryption algorithm of a data link layer defined by 802.a1AE at a cryptographic module, the stability of the encryption algorithm relates to the number of frames that are encrypted with the same key. In other words, if frames having the same packet number are encrypted with the same key, the stability of the algorithm cannot be guaranteed.

Therefore, encryption channels exist as a transmitting channel and a receiving channel independently. If the cryptographic module of the receiving side RX decides a time for updating a cryptographic key, the number of frames received by the cryptographic module of the receiving side RX may be inaccurate because of the possibility of losing the frames, so it is hard to find an accurate time for updating the key. For this reason, the subject that decides the time for updating a cryptographic key should be the cryptographic module of the transmitting side TX.

As described above, in the first embodiment of the present invention, all messages that are transmitted between an OLT and an ONU may be encrypted or only some of the messages may be encrypted even when the security function is activated. In the security function, it is referred as a denial of service (DoS) attack that a message that should be encrypted is received without being encrypted and that a message that should not be encrypted is received with being encrypted.

In the second embodiment of the present invention described later, the operation between a transmitting side TX and a receiving side RX using a function of sensing the DoS attack in EPON. Using the function of sensing the DoS attack, cryptographic modules should be able to perceive and eliminate the DoS attack to receive normal data, and should inform of the type of data encrypted and transmitted to each other when the cryptographic module is activated.

In case that the function for sensing the DoS attack in the EPON is used, a process for activating the cryptographic module will be described with reference to the accompanying drawing.

When the function for sensing the DoS attack in the receiving unit (Rx) is used, the receiving unit (RX) should match data encoding information with the before that the DoS sensing function is activated. Accordingly, when the transmitting unit (TX) confirms that the data encoding information of the receiving unit (RX) is identical with the transmitting unit (TX), the transmitting unit (TX) can activate the DoS sensing function.

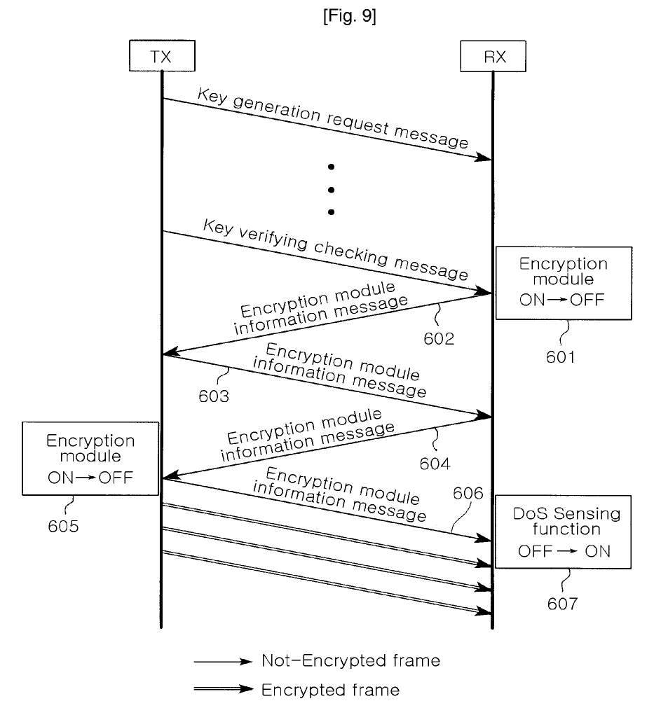

FIG. 9 is a flowchart describing an operation for activating a cryptographic module including a DoS attack sensing function in the EPON according to a second embodiment of the present invention.

At step S601, when the receiving unit (RX) receives a key verification checking message from the transmitting unit (TX) through a key allocating process, a cryptographic module (120R) is operated. At step S602, the receiving unit (RX) maintains the DoS sensing function in the off state, i.e., in the deactivated mode, and transmits a module encoding information message to the transmitting unit (TX) to notify that the current cryptographic module (120R) is in “on” state, i.e., in the activated mode. The module encoding information message includes information showing that entire data encoding information is deactivated and information showing that the DoS sensing function is deactivated. The data encoding information means on/off information in kinds of data to be encoded. In the data encoding information, when the kinds of data is divided into a data message and a control message, a function that does not encode both of data message and control message although the cryptographic module is activated, but encodes a part of the messages is used.

At step S603, the transmitting unit (TX) receiving the module encoding information message activates the cryptographic module (120T), and transmits the module encoding information message including the required data encoding information set up to be activated to the receiving unit (RX). At step S604, the receiving unit (RX) changes own organization information based on the data encoding information included in the module encoding information message and transmits the transmitted module encoding information message including the changed data encoding information to the transmitting unit (TX) again.

At step S605, the transmitting unit (TX) checks whether the data encoding information transmitted from the receiving unit (RX) is the same as own data encoding information. When the data encoding information transmitted from the receiving unit (RX) is the same as own data encoding information, the transmitting unit (TX) activates the cryptographic module (120T). At step S606, the transmitting unit (TX) transmits the module encoding information message including information that the current cryptographic module (120T) is activated to the receiving unit (RX), encodes a frame and transmits the encoded frame to the receiving unit (RX). At step S607, the receiving unit (RX) checks the transmitted module encoding information message, changes the state of the DoS sensing function of the cryptographic module (102R) from “off” into “on” and receives the encoded frame from the transmitting unit (TX).

When the function for sensing the DoS attack in the EPON is used, a process for deactivating the cryptographic module will be described in detail with reference to the attached drawing.

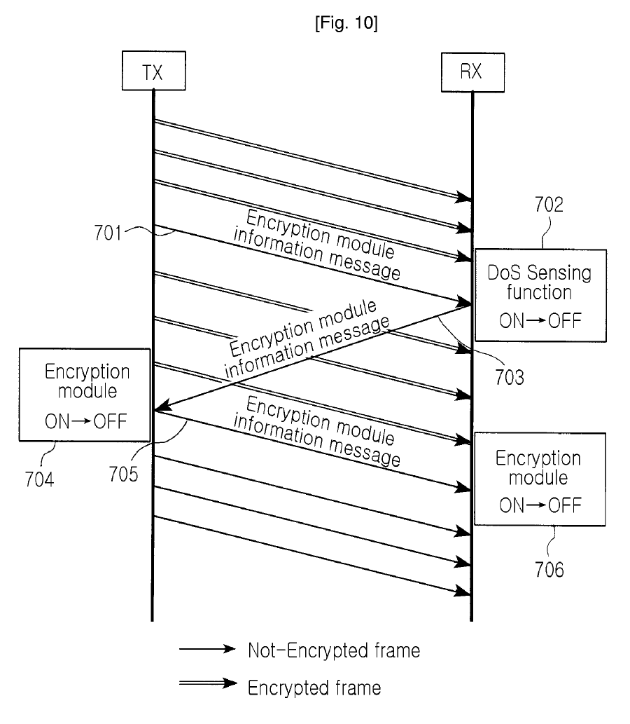

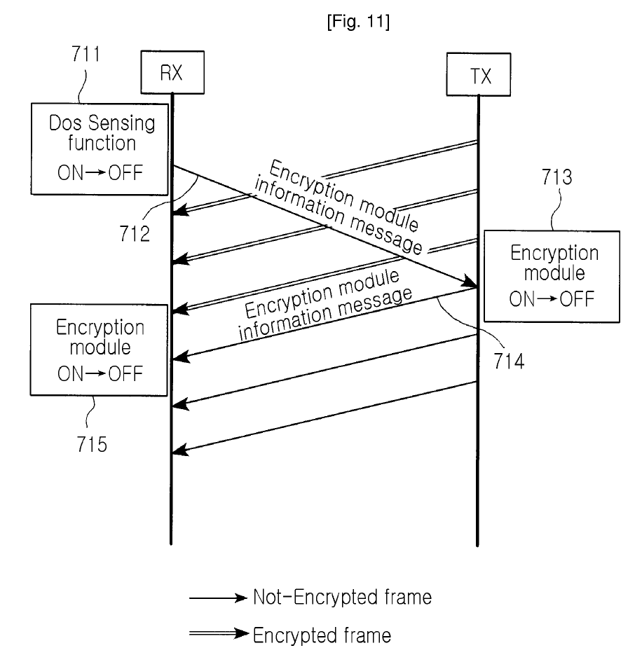

FIGS. 10 and 11 are flowcharts describing an operation for deactivating the cryptographic module including the DoS attack sensing function in the EPON according to the second embodiment of the present invention.

When the transmitting unit (TX) starts to deactivate a securing function, the transmitting unit (TX) should prevent that a non-encoded normal frame is removed due to the DoS function by deactivating the DoS sensing function of the receiving unit before deactivating the cryptographic module (120T).

Referring to FIG. 10, the transmitting unit (TX) transmits a module encoding information message to the receiving unit (RX) at step S701. The module encoding information message includes information showing that the DoS sensing function is in a deactivated mode.

At step S702, the receiving unit (RX) checks the transmitted module encoding information message and deactivates the DoS sensing function of the cryptographic module (120R).

At step S703, the receiving unit (RX) transmits a module encoding information message showing that the DoS sensing function is deactivated to the transmitting unit (TX).

At step S704, the transmitting unit (TX) changes the state of the cryptographic module (120T) from “on” to “off”. At step S705, the transmitting unit (TX) transmits a module encoding information message notifying that own cryptographic module (120T) is deactivated to the receiving unit (RX). At step S706, the receiving unit (RX) deactivates the cryptographic module (120R).

Referring to FIG. 11, when the receiving unit (RX) starts to deactivate a securing function, the receiving unit (RX) deactivates the DoS sensing function of own cryptographic module (120R) at step S711 and transmits a module encoding information message notifying that the DoS sensing function of the receiving unit (RX) is deactivated to the transmitting unit (TX) at step S712. At step S713, the transmitting unit (TX) changes the state of the cryptographic module (120T) from “on” to “off” and transmits a module encoding information message showing that the cryptographic module of the transmitting unit (TX) is deactivated to the receiving unit (RX) at step S714. At step S715, the receiving unit (RX) changes the state of own cryptographic module (120R) from “on” to “off”.

In case that the function for sensing the DoS attack is used as described above, a process of changing the data encoding information of the transmitting/receiving units without ending the securing function when the data encoding information is changed will be described with reference to the attached drawing.

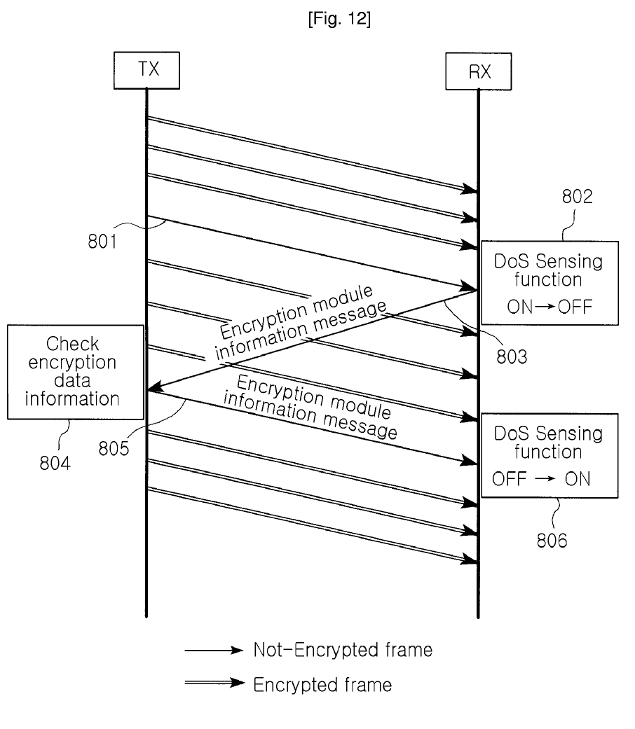

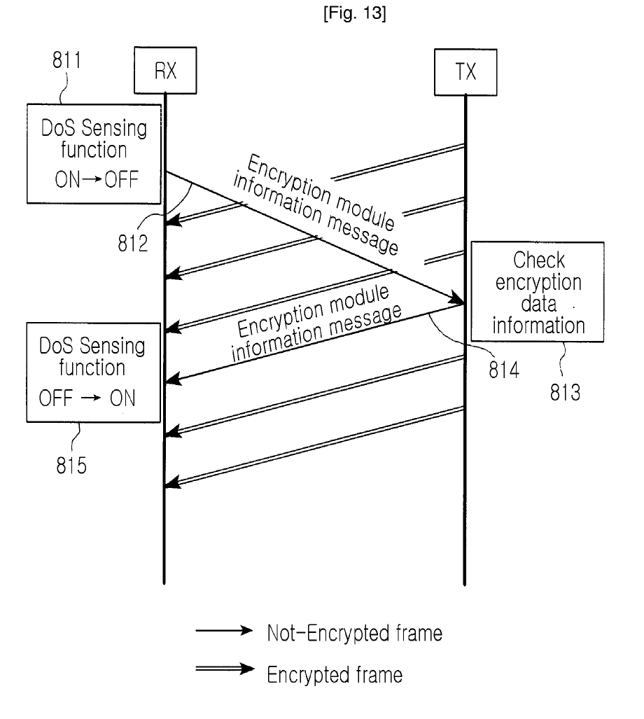

FIGS. 12 and 13 are flowcharts describing an operation for changing encoding data according to the second embodiment of the present invention.

Referring to FIG. 12, when the transmitting unit (TX) requests to change the encoding data, the transmitting unit (TX) transmits a module encoding information message to the receiving unit (RX) at step S801. Since it should be prevented that a non-encoded normal frame is removed due to the DoS function by deactivating the DoS sensing function of the receiving unit (RX), the module encoding information message includes information notifying that the DoS sensing function is in a deactivated mode.

At step S802, the receiving unit (RX) receiving the module encoding information message deactivates the DoS sensing function. At step S803, the receiving unit (RX) transmits a module encoding information message including information notifying that the DoS sensing function is deactivated to the transmitting unit (TX). At step S804, the transmitting unit (TX) checks data encoding information of the transmitted message to discern the deactivated securing function from the process of changing the data encoding information. When the data encoding information of the transmitted message is not identical with the data encoding information of the current receiving unit, the transmitting unit (TX) confirms that the data encoding information is the process of changing the data encoding information. Subsequently, the transmitting unit (TX) transmits a message having the data encoding information of the receiving unit (Rx) and transmitting unit (TX) at step S805.

When the transmitting unit (TX) confirms that the data encoding information of the transmitting unit (TX) is identical with the data encoding information of the receiving unit (RX), the receiving unit (RX) transmits a module encoding information message including information for activating the DoS sensing function to the receiving unit (RX) at step S805. The receiving unit (RX) receiving the module encoding information message activates the DoS sensing function at step S806.

Referring to FIG. 13, when the receiving unit (RX) requests to change the encoding data, the receiving unit (RX) deactivates the DoS sensing function at step S811, and transmits a module encoding information message including information notifying that the DoS sensing function of the receiving unit (RX) is deactivated to the transmitting unit (TX) at step S812. At step S813, the transmitting unit (TX) checks the data encoding information of the transmitted message to discern the deactivated securing function from the process of changing the data encoding information.

When the module encoding information of the transmitted message is not identical with the data encoding information of the current transmitting unit (TX), the transmitting unit (TX) recognizes that the module encoding information of the transmitted message is the process of changing the data encoding information. At step S814, the transmitting unit (TX) transmits a module encoding information message including data encoding information of the transmitting unit (TX) and the receiving unit (RX). At step S815, the receiving unit (RX) checks whether own data encoding information is identical with the data encoding information of the transmitting unit (TX) and activates the DoS sensing function.

As described in the above, the present invention based on the embodiments suggests a method for deciding a time for activating/deactivating the transmitting unit (TX) and the receiving unit (RX) of the cryptographic module in case that the function for sensing the DoS attack in the EPON is used or not used. A key managing protocol, to which the above-mentioned embodiments are applied, will be described hereinafter.

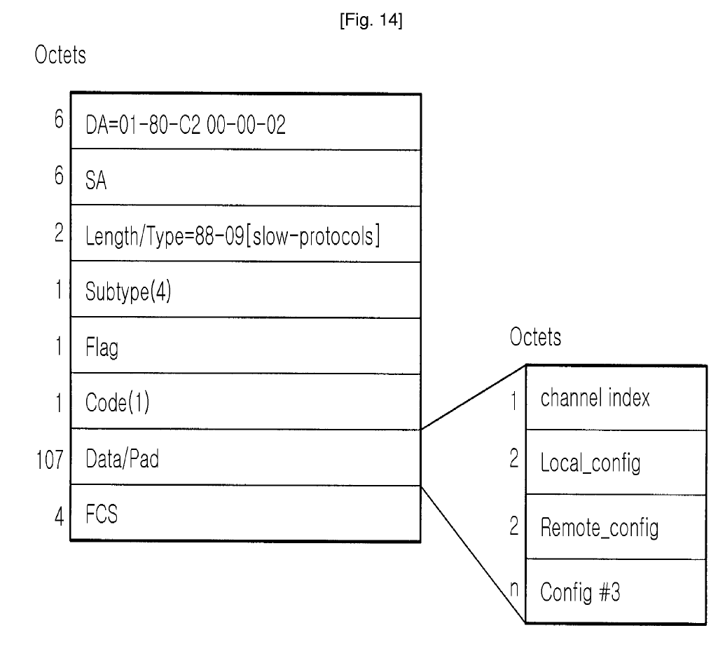

FIG. 14 shows a structure of an information key managing frame according to an embodiment of the present invention.

The protocol, which applies into the embodiments of the present invention, is used in a data link layer, and uses a frame created and disappeared between the OLT and the ONU. That is, the key managing protocol uses a Media Access Control (MAC) frame created and disappeared in the EPON section to transmit information required for the OLT and the ONU. There is a conventional OAM frame as the MAC frame created and disappeared in the EPON section and the key managing protocol uses a slow protocol as the OAM protocol.

When the MAC frame used in the data link layer is formed as a frame proper to the key managing protocol, the MAC frame can have the same frame structure as the structure of FIG. 14. The frame used in the key managing protocol is called a key managing frame.

Each field of the key managing frame has a meaning as shown in Table 1 below.

TABLE 1

Destination Address (DA): 6 bytes. MAC address of the
receiving unit (Rx)Source Address (SA): 6 bytes. MAC
address of transmitting unit (Tx)Length/Type: 2 bytes.
Length and type informationSubtype: 1 byte. Subtype
informationFlag: 1 byte. Defining contents to be checked
whenever the key managing frame is transmittedCode:
1 byte. Classifying kinds of the key managing framesData/
Pad: Maximum 107 bytes. Variable length. Defining
contents of the message to be transmitted in the key
managing frameFCS: 4 bytes. Defining a value for checking
an error of the key managing frame

By applying a rule of the slow protocol, the DA should have a value of 01-80-c2-00-00-02 and the Length/Type should have a value of 88-09. The Subtype uses 4 among 4 to 10 except conventionally used values of 1 to 3. Since a minimum length of the MAC frame is 64 bytes, the Data/Pad should have a value of at least 43 bytes. A maximum of the MAC frame is 107 bytes. Although the maximum length of the MAC frame is 1522 bytes, the key managing frame can extend information by 107 bytes since the maximum length of the frame used in the slow protocol is limited by 128 bytes.

TABLE 2

| Bit | Name | Description |
|---|---|---|
| 0 | Local set | 0 means that the cryptographic module does not |
| | done | exist in a local device, or is not set up. 1 |
| | | means that the cryptographic module exists in |
| | | the local device, and is set up. |
| 1 | Remote set | 0 means that the cryptographic module does not |
| | done | exist in a remote device, or is not set up. 1 |
| | | means that the cryptographic module exists in |
| | | the remote device, and is set up. |
| 2 | Local control | O means that cryptographic module control |
| | done | information of the local device is unstably set |
| | | up. 1 means that the cryptographic module |
| | | control information of the local device is |
| | | stably set up. |
| 3 | Remote | O means that cryptographic module control |
| | control done | information of the remote device is unstably set |
| | | up. 1 means that the cryptographic module |
| | | control information of the remote device is |
| | | stably set up. |
| 4-7 | reserved | |

Table 2 describes bit information of a flag field and the set done bit is divided into “local” and “remote”. When the OLT transmits a key managing frame to the ONU, the local set done designates the module encoding information of the OLT and the remote set done designates the module encoding information of the ONU.

When the bit value is 0, encoding is not performed since the cryptographic module does not exist or the cryptographic module control information is not stably set up. When the cryptographic module does not exist, the key managing module can exist or does not exist. When the key managing module does not exist, there is no response to a request. When the key managing module exists, the bit value is filled with 0 and others are filled with null values. In two cases that the key managing module exists or does not exist, the cryptographic module cannot be normally operated and is processed as “0”. Meanwhile, a case that the bit value is 1 means a state that the cryptographic module can be operated since the cryptographic module exists, and the cryptographic module and the cryptographic module control information are stably set up. Therefore, when both of local set done and remote set done are 1, the cryptographic module can be operated.

In Table 2, the control done bit is divided into “local” and “remote”. When the OLT transmits the key managing frame to the ONU, the local control done designates the module encoding information of the OLT and the remote control done designates the module encoding information of the ONU. The bit is used to determine an operation state of the cryptographic module in the OLT and the ONU. When the OLT and the ONU changes the operation state of the current cryptographic module, the OLT and the ONU set up 1 as 0 and transmits the changed information. Accordingly, the receiving unit compares the transmitted information with own information and searches changed information or information to be changed.

As shown in FIG. 6, when the cryptographic module of the receiving unit (RX) is changed from the deactivated mode to the activated mode and there is nothing to be changed, the local control done is set up as 1 and the remote control done is set up as 0. Subsequently, the module encoding information message, i.e., the information key managing frame, including the changed information, is transmitted to the transmitting unit (TX). Accordingly, the transmitting unit (TX) recognizes that the securing function is operated since the cryptographic module of the receiving unit (RX) is changed from the deactivated mode to the activated mode. Also, the transmitting unit (TX) changes own cryptographic module from the deactivated mode to the activated mode and the local control done becomes 1.

A code field is 1 byte and can classify kinds of the key managing frames. The key managing frame defined in the present invention is as shown in Table 3 below.

TABLE 3

| Code | | |
|---|---|---|
| Value | Name | Description |
| 1 | information key | organization information of cryptographic |
| | managing frame | module and key managing module |

The frame shown in Table 3 is used to transmit own key managing module organization information and organization information of the cryptographic module to other key managing module in the key managing module. The bit information of the organization information is as shown in Table 4 below and organizes a data field.

TABLE 4

| Bit | Name | Description |
|---|---|---|
| 0-1 | Operation state | 0 = Null1 = cryptographic module off2 = |
| | of cryptographic | cryptographic module on |
| | module | |
| 2-4 | Encoding algorithm | 0 = Null1 = GCM-AES-1282 = CCM- |
| | | AES-1283 = OCB-AES-1284 = RSA5-7 = |
| | | reserved |
| 5-7 | Key allocating | 0 = Null1 = no-Diffie-Hellman2 = Diffie- |
| | algorithm | Hellman3-7 = reserved |
| 8 | DoS sensing | 0 = off1 = on |
| | function operation | |
| | state | |
| 9 | Data frame | 0 = no encoding 1 = encoding |
| 10 | OAM frame | 0 = no encoding 1 = encoding |
| 11 | MPCP frame | 0 = no encoding 1 = encoding |
| 12 | Key managing frame | 0 = no encoding 1 = encoding |
| 13-15 | reserved | |

The organization information is transmitted only when the cryptographic module exists. When the cryptographic module does not exist, the operation state has a null value and organization information is filled with null values.

A channel designates a kind of the channels corresponding to the organization information. When GCM-AES of 802.1AE is used as an encoding algorithm in the cryptographic module of the EPON, an upward channel and a downward channel can be individually organized.

The operation state is a bit for checking whether the current cryptographic module exists or does not exist in a system, and checking whether the current cryptographic module is in operation. That is, when other information of the organization information have same synchronizations and set done bit information of the flag is 1, the deactivated mode can be changed into the activated mode.

All encoding algorithms used to encode and decode data in the cryptographic module are a symmetric key algorithm except RSA. The cryptographic module can have an individual module for operating a plurality of encoding algorithms in some cases.

A key allocating algorithm is a bit for transmitting a method for allocating a key in the key managing module and two algorithms are described as an example. However, when the encoding channel is respectively formed to allocate the key, the key allocating algorithm designates algorithm information used in the key allocation cryptographic module.

A Data frame, an OAM frame, an MPCP frame, and a key managing frame designates data encoding information and a DoS sensing function designates an operation state of the DoS sensing function.

The organization information setup of the OLT and the ONU using the information key managing frame ends before a key allocating process. Accordingly, when the receiving unit (RX) receiving the key verification checking message transmits the information key managing frame, the receiving unit (RX) do not change values of bits 2 to 7 of the organization information since the values of bits 2 to 7 are pre-set. Values of bits 0, 1, 8 to 12 of the organization information should be set up.

Finally, a channel index field is organized as follows.

TABLE 5

| Bit | Name | Description |
|---|---|---|
| 0 | Direction | TX = 0RX = 1 |
| 1-7 | Channel ID | ID designating a specific channel |

A channel index is located in front of the organization information and shows, on which channel the organization information is.

As shown in the first embodiment of the present invention, when the securing function operated after allocating the key to apply the securing technology in the EPON is activated or deactivated, the securing function starts to be activated or deactivated not in an access point, but in the securing module of the transmitting unit (TX) for encoding a frame, i.e., in the cryptographic module. Accordingly, the securing function can be activated or deactivated without depending on the access point and it is possible to maintain an independent transmission/reception securing channel. Also, since the securing function is activated in connection with the key allocation of the transmitting unit (TX), securing function activating time of the transmitting unit (TX) can be acquired by transmitting one message.

As described in the second embodiment of the present invention, when the securing function is changed from the activated mode to the deactivated mode, it can be prevented by applying the function for sensing the DoS state in the EPON that the transmitted frame is considered as the DoS and lost. Also, when the function for sensing the DoS state is used, the organization information of the data encoding information can be changed without disconnecting the securing channel.

In addition, outflow of the key managing frame to the outside of the EPON section can be prevented by using the message using the slow protocol in a technology for activating and deactivating the securing function in the embodiments of the present invention. Accordingly, the key managing frame can not be acquired in the outside of EPON and it is possible to maintain a safe environment. Also, since the slow protocol limits the number and a length of the frame, which can be transmitted for 1 second, by 10 and 128 bytes, respectively, the amount of the traffic in the EPON is not affected.

While the present invention has been described with respect to certain preferred embodiments, it will be apparent to those skilled in the art that various changes and modifications may be made without departing from the scope of the invention as defined in the following claims.

1. A method of controlling security of a communication channel between an optical line terminal (OLT) and an optical network unit (ONU) in a secure channel control system of an Ethernet passive optical network formed of an optical line terminal and an optical network unit having a cryptographic module, a key management module and a transmitter/receiver for transmitting/receiving frames, the method comprising the steps of:
a) distributing a key between the OLT and the ONU;
b) transferring the distributed key to the encryption modules of the OLT and ONU;
c) activating a corresponding encryption module using the distributed key at one of the OLT and the ONU which starts a security function activation;
d) transmitting an encryption module information message including activation state information of the corresponding encryption module from the side (transmitting side) having the activated encryption module to an opponent side (receiving side); and
e) activating an encryption module by checking activation state information of the encryption module at the receiving side.

2. The method of claim 1, further comprising the steps of:
f) deactivating the encryption module of the transmitting side when using the security is interrupted;
g) transmitting an encryption module information message having deactivation state information of an encryption module of the transmitting side; and
h) deactivating the encryption module of the receiving side.

3. The method of claim 2, further comprising the step of transmitting an encryption module information message including information for deactivating the encryption module of the transmitting side to the transmitting side when the receiving side begins deactivation of a security function.

4. The method of claim 1, wherein the step a) includes the steps of:
requesting the opponent receiving side to transmit a key when the transmitting side begins the key distribution;
creating the key at the receiving side and transmitting the created key to the transmitting side;
requesting the created key to verify from the transmitting side to the receiving side;
verifying the created key at the receiving side, and transmitting a response of the created key verifying request to the transmitting side; and
transmitting a result of verifying the key according to the key verifying response from the transmitting side to the receiving side.

5. The method of claim 1, wherein the step a) includes the steps of:
requesting the transmitting side to create a key at the receiving side when the receiving side begins the key-distribution;
creating the key at the transmitting side, and transmitting a response for the key-generation to the receiving side;
requesting the transmitting side to verify the created key at the receiving side;
verifying the created key at the transmitting side, and transmitting a response according to the created key verifying request; and
transmitting a result of verifying the key according to the key verifying response at the receiving side.

6. The method of anyone of claims 4 and 5, wherein the key is managed by a key management protocol using a slow protocol, and the key management protocol includes a key management frame using a frame created and deleted at the transmitting side and the receiving side using in a data layer.

7. A method of controlling security of a communication channel between an optical line terminal (OLT) and an optical network unit (ONU), in a secure channel control system of an Ethernet passive optical network having an optical line terminal (OLT) and an optical network unit (ONU) including an encryption module, a key management module and a transmitter/receiver for transmitting and receiving a frame, the method comprising the steps of:
a) distributing a key between the OLT and the ONU;
b) transmitting the distributed key to an encryption module of the OLT and the ONU;
c) activating a corresponding encryption module at one between the OLT and the ONU which starts activating a security function using the distributed key;
d) transmitting an encryption module information message including activation state information of the corresponding encryption module from the side having the activated encryption module (transmitting side) to an opponent side (receiving side);
e) activating an encryption module by checking activation state information of the encryption module at the receiving side that receives the encryption module information message; and
f) activating a function of sensing denial of service of each encryption module as the encryption modules of the transmitting side and the receiving side are activated.

8. The method of claim 7, wherein the step a) includes the steps of:
requesting the receiving side to create a key at the transmitting side when the transmitting side begins key distribution;
creating the key at the receiving side and transmitting the key to the transmitting side;
requesting the receiving side to verify the created key from the transmitting side;
verifying the created key at the receiving side, and transmitting a response to the created key verifying request to the transmitting side; and
transmitting a result of verifying the key according to the key verifying response from the transmitting side to the receiving side.

9. The method of claim 7, wherein the step a) includes the steps of:
requesting the transmitting side to create a key at the receiving side when the receiving side begins the key distribution;
transmitting a response of the key generation to the receiving side by generating the key at the transmitting side;
requesting the transmitting side to verify the created key at the receiving side to the transmitting side;
verifying the created key at the transmitting side, and transmitting a response of the created key verifying request to the receiving side; and
transmitting a result of key verification according to the key verifying response from the receiving side to the transmitting side.

10. The method of anyone of claims 8 and 9, wherein the key is managed by a key management protocol using a slow protocol, and the key management protocol includes a key management frame configured of using a frame created and deleted at the transmitting side and the receiving side using a data layer.

11. The method of claim 7, further comprising the steps of:
g) deactivating a function of sensing denial of service at the receiving side when one of the OLT and the ONU starts the security function deactivation;
h) transmitting an encryption module information message including information noticing that the function of sensing denial of service is deactivated from the receiving side to the transmitting side;
i) transmitting an encryption module information message including information the noticing that the encryption module is deactivated to the receiving side after deactivating own encryption module by checking the encryption module information message at the transmitting side; and
j) deactivating own encryption module by checking the encryption module information message at the receiving side.

12. The method of claim 11, further comprising the step of transmitting an encryption module information message including information for deactivating a function of sensing the denial of service to the receiving side when the transmitting side starts activation of a security function.

13. A method of controlling security of a communication channel between an optical line terminal (OLT) and an optical network unit (ONU) in a security channel control system in an Ethernet passive optical network having an encryption module, a key management module and a transmitter/receiver for transmitting and receiving a frame, the method comprising the steps of:
deactivating a function of sensing denial of service in a side (receiving side) receiving the frame among the OLT and the ONU when one of the OLT and the ONU requests encryption data information to change;
transmitting an encryption module information message from the receiving side to an opponent side (transmitting side);
comparing the encryption module information message with encryption data information and pre-stored data information to determine whether they are matched or not at the transmitting side;
transmitting encryption module information message for changing encryption data information to the receiving side when the encryption data information is not matched;
comparing encryption data information including an encryption module information message received from the transmitting side to own encryption data information at the receiving side to determine whether they are matched; and
activating a function of sensing denial of service at the receiving side when the encryption data information are matched.

14. The method of claim 13, further comprising the step of transmitting an encryption module information message including information for deactivating a function of sensing denial of service at the receiving side when the transmitting side requests encryption data information to change.

15. An apparatus for controlling security of channel between an optical line terminal (OLT) and an optical network unit (ONU) in an Ethernet passive optical network having the OLT and the ONU as a transmitter and a receiver for transmitting or receiving a frame, the apparatus comprising:
an encryption module for activating and deactivating according to a request from one starting activating and deactivating a security function between the OLT and the ONU, and activating an encryption module of the opponent side by transmitting an encryption module information message including information noticing that the encryption module is activated or deactivated to the opponent side; and
a key management module for distributing a key between the optical line terminal (OLT) and the optical network unit (ONU) before activating the encryption module, and transmitting the distributed key to the encryption module of the OLT and the ONU.

16. The apparatus of claim 15, wherein each encryption module includes a function of sensing denial of service for a frame transmitted/received between the OLT and the ONU.

17. The apparatus of claim 15, wherein the encryption module are independently activated and deactivated by independently driving a transmission channel and a receiving channel.

18. The apparatus of claim 15, wherein the key management module uses a slow protocol for managing a key, and has a frame structure for managing a key using a frame created and deleted at the OLT and the ONU using a data layer.
